(19) United States
(12) Patent Application Publication
(10) Pub. No.: US 2026/0214244 A1
(43) Pub. Date: Jul. 23, 2026

(54) ENCODING METHOD AND APPARATUS SUITABLE FOR SPATIAL IMAGE

(71) Applicants: BEIJING WODONG TIANJUN INFORMATION TECHNOLOGY CO., LTD., Beijing (CN); BEIJING JINGDONG CENTURY TRADING CO., LTD., Beijing (CN)

(72) Inventors: Xiajie ZHANG, Beijing (CN); Wei WEI, Beijing (CN); Jinghao GUO, Beijing (CN); Feng DU, Beijing (CN)

(73) Assignees: BEIJING WODONG TIANJUN INFORMATION TECHNOLOGY CO., LTD., Beijing (CN); BEIJING JINGDONG CENTURY TRADING CO., LTD., Beijing (CN)

(21) Appl. No.: 19/137,794

(22) PCT Filed: Apr. 28, 2024
(86) PCT No.: PCT/CN2024/090279

§ 371 Date: Jun. 12, 2025

(30) Foreign Application Priority Data
Apr. 28, 2023 (CN) 202310485016.5

(51) Int. Cl. H04N 19/172; H04N 19/105; H04N 19/119

(52) U.S. Cl. CPC H04N 19/172; H04N 19/105; H04N 19/119

(57) ABSTRACT

The present disclosure discloses an encoding method and apparatus suitable for a spatial image. A specific implementation of the method comprises: generating, in accordance with longitudes and latitudes corresponding to a plurality of sampling points at different spatial angles, a spatial picture matrix including a plurality of spatial pictures acquired by the plurality of sampling points; determining, in accordance with a degree of change between the adjacent spatial pictures in the spatial picture matrix, target sizes of sub-matrices corresponding to different regions in the spatial picture matrix; dividing the spatial picture matrix with the sub-matrices corresponding to the different regions in the spatial picture matrix, and obtaining a plurality of picture groups; and encoding, in accordance with respective key frames and predicted frames included in the plurality of picture groups, the spatial pictures in the spatial picture matrix, and generating an encoded file.

### CROSS REFERENCE TO RELATED APPLICATIONS

The patent application claims priority to Chinese Patent Application No. 202310485016.5, entitled “Encoding Method and Apparatus Suitable for Spatial Image”, which was filed on Apr. 28, 2023, and the contents of which are hereby incorporated by reference in its entirety.

### TECHNICAL FIELD

The embodiments of the disclosure relate to the field of computer technology, specifically relate to an encoding technique, and in particular relate to an encoding method and apparatus suitable for a spatial image, a computer-readable medium, and an electronic device.

### BACKGROUND

The current mainstream video encoding and decoding techniques are all on a temporal basis, that is, data of preceding and succeeding frames in a bitstream are temporally continuous, which is a very strong prior condition, meaning that information of preceding and succeeding frames may be safely used in an encoding process. The existing video encoding techniques can be applied to a temporal picture, but not to a spatial picture.

### SUMMARY

The embodiments of the disclosure put forward an encoding method and apparatus suitable for a spatial image, a computer-readable medium, and an electronic device.

In one or more embodiments, an encoding method suitable for a spatial image is provided, the method comprising: generating, in accordance with longitudes and latitudes corresponding to a plurality of sampling points at different spatial angles, a spatial picture matrix including a plurality of spatial pictures acquired by the plurality of sampling points; determining, in accordance with a degree of change between the adjacent spatial pictures in the spatial picture matrix, target sizes of sub-matrices corresponding to different regions in the spatial picture matrix; dividing the spatial picture matrix with the sub-matrices corresponding to the different regions in the spatial picture matrix, and obtaining a plurality of picture groups; and encoding, in accordance with respective key frames and predicted frames included in the plurality of picture groups, the spatial pictures in the spatial picture matrix, and generating an encoded file.

In one or more embodiments, the aforesaid determining, in accordance with a degree of change between the adjacent spatial pictures in the spatial picture matrix, target sizes of sub-matrices corresponding to different regions in the spatial picture matrix comprises: determining, based on a negative correlation between the degree of change between the adjacent spatial pictures in the spatial picture matrix and the target sizes of the sub-matrices, the target sizes of the sub-matrices corresponding to the different regions in the spatial picture matrix.

In one or more embodiments, the aforesaid adjacent sampling points among the plurality of sampling points are arranged at intervals of a preset degree in a longitude direction and a latitude direction, and the aforesaid determining, based on a negative correlation between the degree of change between the adjacent spatial pictures in the spatial picture matrix and the target sizes of the sub-matrices, the target sizes of the sub-matrices corresponding to the different regions in the spatial picture matrix comprises: determining, in response to determining that the degree of change between the adjacent spatial pictures in the latitude direction in the spatial picture matrix is greater than the degree of change between the adjacent spatial pictures in the longitude direction, that the length of the sub-matrix is greater than the width thereof, wherein the length direction of the sub-matrix corresponds to the longitude direction of the sampling point, and the width direction of the sub-matrix corresponds to the latitude direction of the sampling point; determining, in response to determining that the degree of change between the adjacent spatial pictures in the longitude direction in the spatial picture matrix is negatively correlated with a latitude value, that the length of the sub-matrix is positively correlated with the latitude value; and determining, based on the length of the sub-matrix being greater than the width thereof and the positive correlation between the length of the sub-matrix and the latitude value, the target sizes of the sub-matrices in the different regions in the spatial picture matrix.

In one or more embodiments, the aforesaid generating, in accordance with longitudes and latitudes corresponding to a plurality of sampling points at different spatial angles, a spatial picture matrix including a plurality of spatial pictures acquired by the plurality of sampling points comprises: arranging the plurality of spatial pictures with the longitudes of the sampling points corresponding to the spatial pictures as horizontal axes and the latitudes of the sampling points corresponding to the spatial pictures as vertical axes, and generating the spatial picture matrix.

In one or more embodiments, the aforesaid encoding, in accordance with respective key frames and predicted frames included in the plurality of picture groups, the spatial pictures in the spatial picture matrix, and generating an encoded file comprise: arranging the picture groups corresponding to the sampling points at the same latitude in the plurality of picture groups in an ascending order of the longitudes of the sampling points corresponding to the picture groups, and generating a plurality of picture group sub-sequences; arranging the plurality of picture group sub-sequences in an ascending order of the latitudes of the sampling points corresponding to the picture groups, determining respective picture group identifiers corresponding to the plurality of picture groups, and generating a picture group sequence; arranging the spatial pictures in each picture group in the picture group sequence in an order of key frames followed by predicted frames, determining picture identifiers of the spatial pictures in each of the plurality of picture groups, and generating a spatial picture sequence; and encoding, in accordance with the respective key frames and predicted frames included in the plurality of picture groups, the spatial picture sequence, and generating the encoded file.

In one or more embodiments, the aforesaid arranging the spatial pictures in each picture group in the picture group sequence in an order of key frames followed by predicted frames, determining picture identifiers of the spatial pictures in each of the plurality of picture groups, and generating a spatial picture sequence comprise: determining the spatial pictures at the center positions in the respective sub-matrices corresponding to the plurality of picture groups as initial key frames; for each of the plurality of picture groups, determining, based on the initial key frame of the picture group, the key frame of the picture group in a direction in which the sampling points corresponding to the spatial pictures in the picture group are more sparse, and determining the predicted frame adjacent to the key frame; and arranging the spatial pictures in each picture group in the picture group sequence in an order of key frames followed by predicted frames, determining the picture identifiers of the spatial pictures in each of the plurality of picture groups, and generating the spatial picture sequence.

In one or more embodiments, the aforesaid encoding, in accordance with the respective key frames and predicted frames included in the plurality of picture groups, the spatial picture sequence, and generating the encoded file comprise: for each of the plurality of picture groups, encoding the spatial picture sequence in a reference manner in which the predicted frames in the picture group uniquely refer to the key frame in the picture group, and generating the encoded file.

In one or more embodiments, an encoding apparatus suitable for a spatial image is provided, the apparatus comprising: a first generating unit configured to generate, in accordance with longitudes and latitudes corresponding to a plurality of sampling points at different spatial angles, a spatial picture matrix including a plurality of spatial pictures acquired by the plurality of sampling points; a determining unit configured to determine, in accordance with a degree of change between the adjacent spatial pictures in the spatial picture matrix, target sizes of sub-matrices corresponding to different regions in the spatial picture matrix; a dividing unit configured to divide the spatial picture matrix with the sub-matrices corresponding to the different regions in the spatial picture matrix, and obtain a plurality of picture groups; and a second generating unit configured to encode, in accordance with respective key frames and predicted frames included in the plurality of picture groups, the spatial pictures in the spatial picture matrix, and generate an encoded file.

In one or more embodiments, the aforesaid determining unit is further configured to: determine, based on a negative correlation between the degree of change between the adjacent spatial pictures in the spatial picture matrix and the target sizes of the sub-matrices, the target sizes of the sub-matrices corresponding to the different regions in the spatial picture matrix.

In one or more embodiments, the aforesaid adjacent sampling points among the plurality of sampling points are arranged at intervals of a preset degree in a longitude direction and a latitude direction, and the aforesaid determining unit is further configured to: determine, in response to determining that the degree of change between the adjacent spatial pictures in the latitude direction in the spatial picture matrix is greater than the degree of change between the adjacent spatial pictures in the longitude direction, that the length of the sub-matrix is greater than the width thereof, wherein the length direction of the sub-matrix corresponds to the longitude direction of the sampling point, and the width direction of the sub-matrix corresponds to the latitude direction of the sampling point; determine, in response to determining that the degree of change between the adjacent spatial pictures in the longitude direction in the spatial picture matrix is negatively correlated with a latitude value, that the length of the sub-matrix is positively correlated with the latitude value; and determine, based on the length of the sub-matrix being greater than the width thereof and the positive correlation between the length of the sub-matrix and the latitude value, the target sizes of the sub-matrices in the different regions in the spatial picture matrix.

In one or more embodiments, the aforesaid first generating unit is further configured to: arrange the plurality of spatial pictures with the longitudes of the sampling points corresponding to the spatial pictures as horizontal axes and the latitudes of the sampling points corresponding to the spatial pictures as vertical axes, and generate the spatial picture matrix.

In one or more embodiments, the aforesaid second generating unit is further configured to: arrange the picture groups corresponding to the sampling points at the same latitude in the plurality of picture groups in an ascending order of the longitudes of the sampling points corresponding to the picture groups, and generate a plurality of picture group sub-sequences; arrange the plurality of picture group sub-sequences in an ascending order of the latitudes of the sampling points corresponding to the picture groups, determine respective picture group identifiers corresponding to the plurality of picture groups, and generate a picture group sequence; arrange the spatial pictures in each picture group in the picture group sequence in an order of key frames followed by predicted frames, determine picture identifiers of the spatial pictures in each of the plurality of picture groups, and generate a spatial picture sequence; and encode, in accordance with the respective key frames and predicted frames included in the plurality of picture groups, the spatial picture sequence, and generate the encoded file.

In one or more embodiments, the aforesaid second generating unit is further configured to: determine the spatial pictures at the center positions in the respective sub-matrices corresponding to the plurality of picture groups as initial key frames; for each of the plurality of picture groups, determine, based on the initial key frame of the picture group, the key frame of the picture group in a direction in which the sampling points corresponding to the spatial pictures in the picture group are more sparse, and determine the predicted frame adjacent to the key frame; and arrange the spatial pictures in each picture group in the picture group sequence in an order of key frames followed by predicted frames, determine the picture identifiers of the spatial pictures in each of the plurality of picture groups, and generate the spatial picture sequence.

In one or more embodiments, the aforesaid second generating unit is further configured to: for each of the plurality of picture groups, encode the spatial picture sequence in a reference manner in which the predicted frames in the picture group uniquely refer to the key frame in the picture group, and generate the encoded file.

In one or more embodiments, a computer-readable medium, on which a computer program is stored, is provided, wherein the program, when executed by a processor, implements the method as described in any of the aforesaid implementation.

In one or more embodiments, an electrode device is provided, the electronic device comprising: one or more processors; and a storage means, on which one or more programs are stored, the one or more programs, when executed by the one or more processors, cause the one or more processors to implement the method as described in any of the aforesaid implementation.

It should be understood that the contents described in this part are not intended to identify key or important features of the embodiments of the disclosure, and are not used for limiting the scope of the disclosure either. The other features of the disclosure will become easily understood by means of the descriptions below.

### BRIEF DESCRIPTION OF THE DRAWINGS

The other features, objects, and advantages of the disclosure will become more apparent by reading detailed descriptions of non-limiting embodiments made with reference to the figures below:

FIG. 1 is a diagram of an exemplary system architecture to which an embodiment of the disclosure may be applied;

FIG. 2 is a flow chart of an embodiment of an encoding method suitable for a spatial image according to the disclosure;

FIG. 3 is a schematic diagram of a spatial layout of sampling points in a longitude and latitude sampling manner according to the embodiment;

FIG. 4 is a schematic diagram of a spatial picture matrix according to the embodiment;

FIG. 5 is a schematic diagram of sub-matrices of different regions in the spatial picture matrix according to the embodiment;

FIG. 6 a schematic diagram showing a spatial picture sequence according to the embodiment;

FIG. 7 is a schematic diagram of a reference manner between predicted frames and a key frame in a picture group according to the embodiment;

FIG. 8 is a schematic diagram of an application scenario of the encoding method suitable for a spatial image according to the embodiment;

FIG. 9 is a flow chart of a further embodiment of the encoding method suitable for a spatial image according to the disclosure;

FIG. 10 is a schematic diagram of a decoding track according to the embodiment;

FIG. 11 is a schematic diagram of a screen sliding track according to the embodiment;

FIG. 12 is a diagram of a structure of an embodiment of an encoding apparatus suitable for a spatial image according to the disclosure;

FIG. 13 is a schematic diagram of a structure of a computer system suitable for implementing an embodiment of the disclosure.

### DETAILED DESCRIPTION

The disclosure is further described in detail below in combination with the figures and embodiments. It may be understood that the specific embodiments described herein are only used to explain the relevant invention, rather than to limit the invention. In addition, it should also be noted that in order to facilitate the descriptions, only the parts related to the relevant invention are shown in the figures.

It should be noted that, in a case where there is no conflict, the embodiments and the features in the embodiments in the disclosure may be combined with each other. The disclosure will be described in detail below with reference to the figures and in combination with the embodiments.

It should be noted that in the technical solutions of the disclosure, the acquisition, collection, update, analysis, processing, use, transmission, storage and other aspects of user personal information involved, which all comply with the provisions of relevant laws and regulations, are used for legitimate purposes, and do not violate public order and good customs. Necessary measures are taken for user personal information to prevent an illegal access to user personal information data and maintain user personal information security, network security and national security.

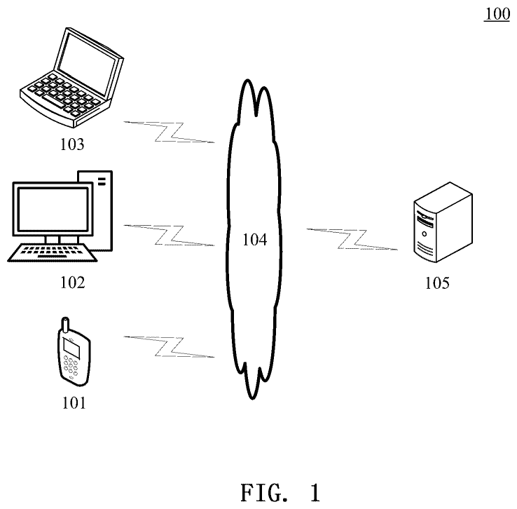

FIG. 1 shows an exemplary architecture 100 of an encoding method and apparatus suitable for a spatial image to which the disclosure may be applied.

As shown in FIG. 1, the system architecture 100 may comprise terminal devices 101, 102 and 103, a network 104, and a server 105. The communication connection between the terminal devices 101, 102 and 103 forms a topological network, and the network 104 is a medium for providing a communication link between the terminal devices 101, 102 and 103 and the server 105. The network 104 may include various connection types, such as wired or wireless communication links, or fiber-optic cables.

The user may use the terminal devices 101, 102 and 103 to interact with the server 105 through the network 104 to receive or send messages and so on. The terminal devices 101, 102 and 103 may be hardware devices or software supporting the network connection to thereby perform data interaction and data processing. When the terminal devices 101, 102 and 103 are the hardware, they may be various electronic devices that support the network connection as well as the information acquisition, interaction, display, processing and other functions, including but not limited to smart phones, image acquisition devices, tablet computers, e-book readers, laptop portable computers, desktop computers, and so on. When the terminal devices 101, 102 and 103 are the software, they may be installed in the electronic devices listed above. They may be implemented as, for example, a plurality of software or software modules for providing distributed services, or they may be implemented as a single software or software module. No specific limitations are given herein.

The sever 105 may be a server that provides various services, such as a backend processing server that receives spatial pictures provided by the terminal devices 101, 102 and 103, utilizes the spatial distribution characteristics of the spatial pictures, and determines an encoding structure of a picture group so as to perform encoding to obtain an encoded file. As an example, the sever 105 may be a cloud server.

It should be noted that the server may be hardware or software. When the server is the hardware, it may be implemented as a distributed server cluster composed of a plurality of servers, or it may be implemented as a single server. When the server is the software, it may be implemented as a plurality of software or software modules (e.g., software or software modules used to provide distributed services), or it may be implemented as a single software or software module. No specific limitations are given herein.

It should also be noted that the encoding method suitable for a spatial image provided by the embodiment of the disclosure may be executed by a server, or may be executed by a terminal device, or may be executed by a server and a terminal device in cooperation with each other. Correspondingly, the various parts (e.g., the various units) included in the encoding apparatus suitable for a spatial image may be entirely arranged in the server, or may be entirely arranged in the terminal device, or may be respectively arranged in the server and the terminal device.

It should be understood that the numbers of the terminal devices, the networks, and the servers in FIG. 1 are merely schematic. According to implementation requirements, there may be any numbers of terminal devices, networks, and servers. When the electronic device on which the encoding method suitable for a spatial image runs is not required to transmit data with other electronic devices, the system architecture may only include the electronic device (e.g., the server or terminal device) on which the encoding method suitable for a spatial image runs.

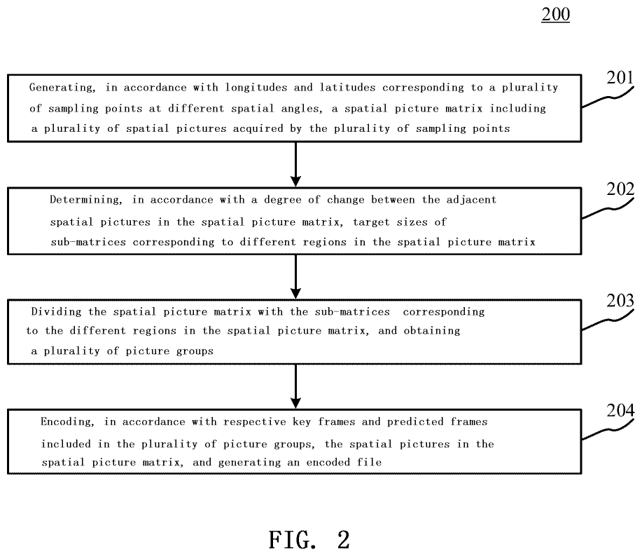

Reference is continued to be made to FIG. 2, which shows a flow 200 of an embodiment of an encoding method suitable for a spatial image, comprising the following steps:

Step 201: generating, in accordance with longitudes and latitudes corresponding to a plurality of sampling points at different spatial angles, a spatial picture matrix including a plurality of spatial pictures acquired by the plurality of sampling points.

In the embodiment, the execution subject of the coding method suitable for a spatial picture (e.g., the terminal device or server in FIG. 1) generates, in accordance with longitudes and latitudes corresponding to a plurality of sampling points at different spatial angles, a spatial picture matrix including a plurality of spatial pictures acquired by the plurality of sampling points. The spatial pictures represent pictures of the target object obtained at different spatial angles. The target object may be a person, a thing, or any other object.

As an example, the plurality of sampling points may be uniformly arranged at different spatial angles so as to shoot the spatial pictures of the target object at different spatial angles, which is known as a uniform sampling manner.

As another example, the plurality of sampling points may be non-uniformly arranged at different spatial angles in a manner of surrounding the target object at preset latitude and longitude intervals so as to shoot the spatial pictures of the target object at different spatial angles, which is known as a longitude and latitude sampling manner.

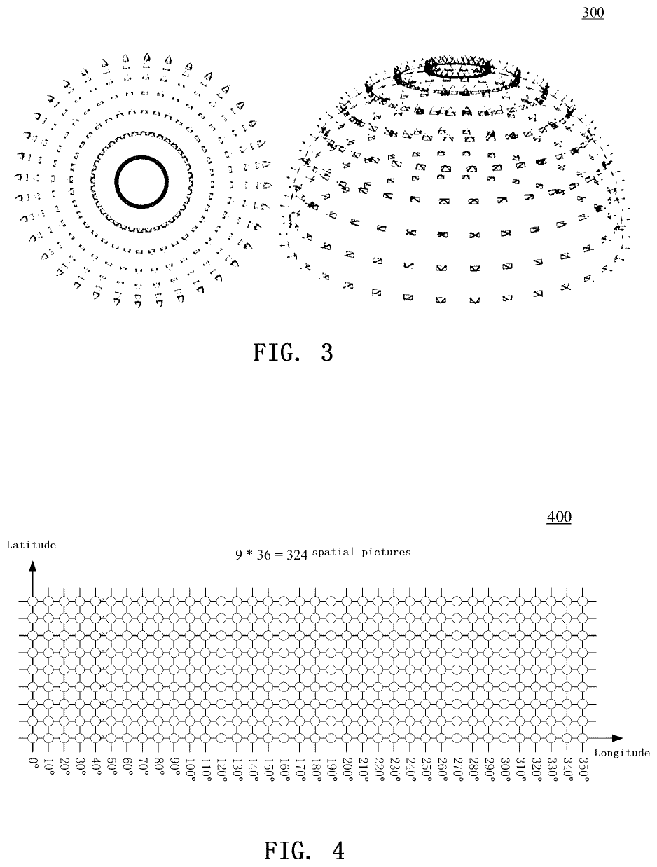

As shown in FIG. 3, a schematic diagram 300 of a spatial layout of sampling points in a longitude and latitude sampling manner is shown. For the upper hemisphere of the target object, sampling is performed at intervals of 10°, so there are 36 sampling points in the longitude direction and 9 sampling points in the latitude direction, and there are 324 (36×9) sampling points in the upper hemisphere of the target object. The left sub-figure in FIG. 3 is a top view of the spatial layout of the sampling points, and the right sub-figure is a main view of the spatial layout of the sampling points.

The longitudes and latitudes corresponding to the sampling points at different spatial angles are different, so the spatial pictures at different spatial angles are obtained by sampling. The spatial pictures at different spatial angles are arranged in a certain arrangement order so as to obtain a spatial picture matrix. As an example, for each spatial picture, the spatial picture is named with the longitude and latitude of the sampling point corresponding to the spatial picture; then, the plurality of spatial pictures are arranged in accordance with the naming information of each spatial picture, and the spatial picture matrix is generated. For example, the longitude and latitude of the sampling point corresponding to the spatial picture are (10°, 20°), and then the spatial picture may be named “10-20.jpg”.

In some optional implementation of the embodiment, the aforesaid execution subject may perform the aforesaid step 201 in the following manner: arranging the plurality of spatial pictures with the longitudes of the sampling points corresponding to the spatial pictures as horizontal axes and the latitudes of the sampling points corresponding to the spatial pictures as vertical axes, and generating the spatial picture matrix.

Specifically, by using the longitudes of the sampling points corresponding to the spatial pictures as horizontal axes and the latitudes of the sampling points corresponding to the spatial pictures as the vertical axes, the plurality of the spatial pictures are arranged in an ascending order of the longitudes and an ascending order of the latitudes, and the spatial picture matrix is obtained.

The aforesaid sampling points shown in FIG. 3 are continued to be used as an example, and the spatial picture matrix generated thereby is as shown in FIG. 4. The range of the latitudes in the spatial picture matrix is 0°-80°, and the range of the longitudes is 0°-350°.

In the implementation, based on the longitudes and latitudes of the sampling points, an arrangement manner that is more in line with the spatial correlation between the plurality of spatial pictures is provided, so that the generated spatial picture matrix is more conductive to spatial encoding so as to improve the spatial encoding efficiency.

Step 202: determining, in accordance with a degree of change between the adjacent spatial pictures in the spatial picture matrix, target sizes of sub-matrices corresponding to different regions in the spatial picture matrix.

In the embodiment, the aforesaid execution subject may determine, in accordance with a degree of change between the adjacent spatial pictures in the spatial picture matrix, target sizes of sub-matrices corresponding to different regions in the spatial picture matrix.

The degree of change between the adjacent spatial pictures represents the degree of change between the picture contents represented by the adjacent spatial pictures or the degree of change in the positions between the respective adjacent sampling points corresponding to the adjacent spatial pictures. For the degree of change between the picture contents, for example, the respective picture features of the adjacent spatial pictures may be extracted by a feature extraction network, and the picture features represent the picture contents of the spatial picture; then, the degree of change between the adjacent spatial pictures is determined by calculating a similarity between the picture features of the adjacent spatial pictures (e.g., cosine similarity or Euclidean distance). The similarity between the adjacent spatial pictures is negatively correlated with the degree of change between the adjacent spatial pictures. As another example, respective histograms corresponding to the adjacent spatial pictures may be determined, and then the degree of change between the adjacent spatial pictures may be determined by the distance between the histograms.

For the degree of change in the positions between the adjacent sampling points, when the distances in the longitude and latitude between the respective sampling points corresponding to adjacent spatial pictures are comparatively long, the degree of change between the adjacent pictures is comparatively great; when the distances in the longitude and latitude between the respective sampling points corresponding to the adjacent spatial pictures are comparatively short, the degree of change between the adjacent pictures is comparatively small. It may be understood that the degree of change between the picture contents of the adjacent spatial pictures acquired by the adjacent sampling points is always positively correlated with the degree of change in the positions between the adjacent sampling points.

As an example, the aforesaid execution subject is provided with a correspondence table representing the correspondence between the degree of change between the adjacent spatial pictures in the spatial picture matrix and the target sizes of the sub-matrices corresponding to the different regions in the spatial picture matrix, so as to determine, in accordance with the correspondence table and the degree of change between the adjacent spatial pictures in the spatial picture matrix, the target sizes of the sub-matrices corresponding to the different regions corresponding to the adjacent spatial pictures in the spatial picture matrix.

As another example, linear fitting is performed based on data of the change of the preset target sizes of the sub-matrices with the degree of change between the adjacent spatial pictures, and a function model between the target sizes of the sub-matrices and the degree of change between the adjacent spatial pictures is determined; then, the target sizes of the sub-matrices corresponding to the different regions in the spatial picture matrix are determined in accordance with the determined function model and the degree of change between the adjacent spatial pictures in the spatial picture matrix.

In some optional implementations of the embodiment, the aforesaid execution subject may perform the aforesaid step 202 in the following manner: determining, based on a negative correlation between the degree of change between the adjacent spatial pictures in the spatial picture matrix and the target sizes of the sub-matrices, the target sizes of the sub-matrices corresponding to the different regions in the spatial picture matrix.

In the longitude and latitude sampling manner as shown in FIG. 3, the degree of change between the adjacent spatial pictures is not the same, which is specifically represented as follows: the degree of change between the adjacent spatial pictures in the longitude direction decreases as the latitude increases.

By adopting the principle that the degree of change between the adjacent spatial pictures in the spatial picture matrix is negatively correlated with the target sizes of the sub-matrices, the smaller the degree of change between the adjacent spatial pictures is, the larger the target size of the sub-matrix of the region where the adjacent spatial pictures are located in the spatial picture matrix is; the greater the degree of change between the adjacent spatial pictures is, the smaller the target size of the sub-matrix of the region where the adjacent spatial pictures are located in the spatial picture matrix is.

The sub-matrix is used to divide the spatial picture matrix in subsequent steps and obtain picture groups. For the spatial pictures with a comparatively small degree of change, a comparatively large picture group is arranged to include more spatial pictures; for the spatial pictures with a comparatively great degree of change, a comparatively small picture group is arranged to include fewer spatial pictures, which is more conducive to the data compression efficiency of the encoding process.

In some optional implementations of the embodiment, the adjacent sampling points among the plurality of sampling points are arranged at intervals of a preset degree in a longitude direction and a latitude direction. The preset degree may be specifically arranged according to actual conditions. As an example, reference is continued to be made to FIG. 3, where the plurality of sampling points are arranged at intervals of 10° in the longitude direction and the latitude direction.

In the implementation, the aforesaid execution subject may determine the target sizes of the sub-matrices in the following manner:
first, determining, in response to determining that the degree of change between the adjacent spatial pictures in the latitude direction in the spatial picture matrix is greater than the degree of change between the adjacent spatial pictures in the longitude direction, that the length of the sub-matrix is greater than the width thereof, wherein the length direction of the sub-matrix corresponds to the longitude direction of the sampling point, and the width direction of the sub-matrix corresponds to the latitude direction of the sampling point; then, determining, in response to determining that the degree of change between the adjacent spatial pictures in the longitude direction in the spatial picture matrix is negatively correlated with a latitude value, that the length of the sub-matrix is positively correlated with the latitude value; and finally, determining, based on the length of the sub-matrix being greater than the width thereof and the positive correlation between the length of the sub-matrix and the latitude value, the target sizes of the sub-matrices in the different regions in the spatial picture matrix.

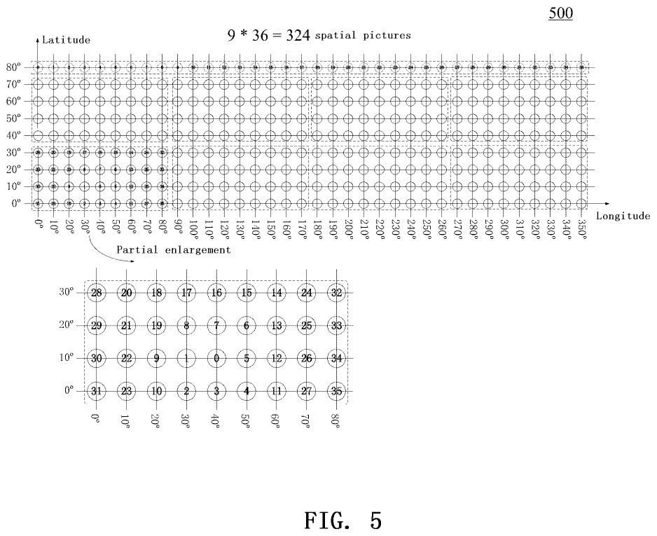

Reference is continued to be made to FIG. 5, which is a schematic diagram 500 showing sub-matrices of different regions in the spatial picture matrix. Under the first principle that the length of the sub-matrix is greater than the width thereof and the second principle that the length of the sub-matrix is positively correlated with the latitude value, the target sizes of the sub-matrices are 9×4 and 36×1, respectively. The target size of the sub-matrices corresponding to the regions where the low-latitude spatial pictures are located is 9×4, and the target size of the sub-matrix corresponding to the region where the high-latitude spatial pictures are located is 36×1.

In the implementation, a specific manner for determining the target sizes of the sub-matrices is provided, and based on the first principle that the length of the sub-matrix is greater than the width thereof and the second principle that the length of the sub-matrix is positively correlated with the latitude value, the adaptability of the determined sub-matrices to the spatial distribution characteristics of the spatial pictures is improved, which facilitates a further increase of the encoding efficiency.

Step 203: dividing the spatial picture matrix with the sub-matrices corresponding to the different regions in the spatial picture matrix, and obtaining a plurality of picture groups.

In the embodiment, the aforesaid execution subject may divide the spatial picture matrix with the sub-matrices corresponding to the different regions in the spatial picture matrix, and obtain a plurality of picture groups.

Reference is continued to be made to FIG. 5, where the spatial picture matrix is divided by the sub-matrices corresponding to the different regions, and 9 picture groups GOP1-GOP9 are obtained. The sub-matrices corresponding to the picture groups GOP1-GOP8 have a size of 9×4, and the sub-matrix corresponding to the picture group GOP9 has a size of 36×1.

Step 204: encoding, in accordance with respective key frames and predicted frames included in the plurality of picture groups, the spatial pictures in the spatial picture matrix, and generating an encoded file.

In the embodiment, the aforesaid execution subject may encode, in accordance with respective key frames and predicted frames included in the plurality of picture groups, the spatial pictures in the spatial picture matrix, and generate an encoded file.

In the compression encoding process, each frame of the spatial pictures represents a still image. During the actual compression, various compression algorithms will be used to reduce the data capacity, where an IPB frame is the most common one. An I frame in the IPB frame is also called a key frame or an intra-frame encoded frame. The key frame is usually the first frame of each picture group, which is moderately compressed and serves as a reference point for a random access to generate a static image. The key frame may be regarded as a product obtained by compressing an image, and compression may remove redundant information from the video. A P frame is also called a predicted frame or a forward predicted encoding frame. For the compressed data corresponding to the predicted frame, redundant information that is the same as the compressed data corresponding to the key frame in the same picture group is removed, and the encoded data corresponding to the predicted frame is obtained. The predicted frame represents the difference between the predicted frame and the corresponding key frame, and during decoding, it is required to refer to the corresponding key frame and the decoded data corresponding to the predicted frame, and generate the spatial picture corresponding to the predicted frame.

In the embodiment, a determination manner may be preset to determine key frames and predicted frames in the picture groups; then, the spatial pictures in the spatial picture matrix are encoded in accordance with the respective key frames and predicted frames included in the plurality of picture groups, and the encoded file is generated.

For example, for each of the plurality of picture groups, the spatial picture corresponding to the sampling point with the smallest longitude and latitude in the picture group is used as the key frame, the remaining spatial pictures in the picture group are used as the predicted frames, the spatial pictures in the spatial picture matrix are encoded, and the encoded file is generated.

In some optional implementations of the embodiment, the aforesaid execution subject may perform the aforesaid step 204 in the following manner:

First: arranging the picture groups corresponding to the sampling points at the same latitude in the plurality of picture groups in an ascending order of the longitudes of the sampling points corresponding to the picture groups, and generating a plurality of picture group sub-sequences.

Reference is continued to be made to FIG. 5, where the plurality of picture group sub-sequences include a first picture group sub-sequence, a second picture group sub-sequence, and a third picture group sub-sequence. The first picture group sub-sequence is “GOP1→GOP2→9GOP3→GOP4”, the second picture group sub-sequence is “GOP5→GOP6→9GOP7→GOP8”, and the third picture group sub-sequence is GOP9.

Second: arranging the plurality of picture group sub-sequences in an ascending order of the latitudes of the sampling points corresponding to the picture groups, determining respective picture group identifiers corresponding to the plurality of picture groups, and generating a picture group sequence.

Reference is continued to be made to FIG. 5, where the picture group sequence is “GOP1→GOP2→GOP3 . . . →GOP8→GOP9”.

Third: arranging the spatial pictures in each picture group in the picture group sequence in an order of key frames followed by predicted frames, determining picture identifiers of the spatial pictures in each of the plurality of picture groups, and generating a spatial picture sequence.

Specifically, based on the determined picture group sequence, for the spatial pictures in each picture group, the picture sequence in the picture group is determined in an order of key frames followed by predicted frames. Then, according to the image sequence corresponding to the image group, the picture identifiers of the spatial pictures in each picture group are determined, and the spatial picture sequence is finally obtained.

For the plurality of predicted frames in each picture group, the arrangement order of the plurality of predicted frames may be determined in accordance with a preset determination manner. For example, the plurality of predicted frames are arranged in an ascending order of the latitudes and an ascending order of the longitudes of the sampling points corresponding to the spatial pictures.

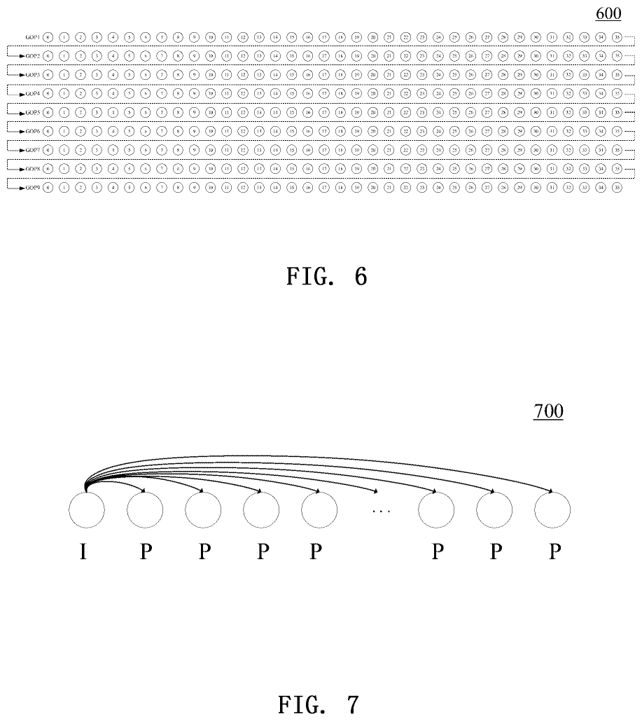

Reference is continued to be made to FIG. 6, which is a schematic diagram showing a spatial picture sequence. In each picture group, the key frame corresponds to the identifier “0”, and the predicted frames correspond to the identifiers “1-35”.

Fourth: encoding, in accordance with the respective key frames and predicted frames included in the plurality of picture groups, the spatial picture sequence, and generating the encoded file.

In the implementation, the spatial picture matrix is first arranged to obtain the spatial picture sequence, and then encoding is performed in accordance with the arrangement order of the spatial pictures in the spatial picture sequence, and the key frame and predicted frames in each picture group, which further increases the efficiency and accuracy of the encoding process.

In some optional implementations of the embodiment, the aforesaid execution subject may perform the aforesaid third step in the following manner: first, determining the spatial pictures at the center positions in the respective sub-matrices corresponding to the plurality of picture groups as initial key frames; then, for each of the plurality of picture groups, determining, based on the initial key frame of the picture group, the key frame of the picture group in a direction in which the sampling points corresponding to the spatial pictures in the picture group are more sparse, and determining the predicted frame adjacent to the key frame; and finally, arranging the spatial pictures in each picture group in the picture group sequence in an order of key frames followed by predicted frames, determining the picture identifiers of the spatial pictures in each of the plurality of picture groups, and generating the spatial picture sequence.

The sub-matrix having a size of 9×4 shown in FIG. 5 is continued to be used as an example. For the 36 spatial pictures in the picture group obtained by means of the division, based on the initial key frame at the center position, the key frame is determined in a direction in which the sampling points corresponding to the spatial pictures in the picture group are more sparse, that is, in a direction in which the latitude is smaller, specifically at the position (40, 10). Then, for the predicted frames around the key frame, the sorting information of the plurality of predicted frames is determined in a bilaterally symmetrical manner, and the spatial pictures in each picture group in the picture group sequence are arranged so as to determine the picture identifiers of the spatial pictures in the picture group. As an example, for a picture group corresponding to the sub-matrix having a size of 9×4, the picture identifiers of the spatial pictures in the picture group may be determined with reference to the encoding order in the picture group GOP1 in FIG. 5.

For the picture group corresponding to the sub-matrix having a size of 36×1, since the degree of change between the adjacent spatial pictures is very small, any spatial picture therein may be determined as the key frame. For example, the first spatial picture in the picture group is determined as the key frame, and then the spatial pictures in the picture group are arranged in an ascending order of the longitudes, and the picture identifiers of the spatial pictures in the picture group corresponding to the sub-matrix having a size of 36×1 are determined.

Based on the initial key frame at the center position, the key frame is determined in the direction in which the sampling points corresponding to the spatial pictures in the picture group are more sparse, so that the degrees of change between the key frame and the surrounding predicted frames in the picture group are comparatively small, which further facilitates the encoding efficiency of the encoding process and reduces the data volume of the encoded file.

In some optional implementations of the embodiment, the aforesaid execution subject may perform the fourth step in the following manner: for each of the plurality of picture groups, encoding the spatial picture sequence in a reference manner in which the predicted frames in the picture group uniquely refer to the key frame in the picture group, and generating the encoded file.

Reference is continued to be made to FIG. 7, which is a schematic diagram 700 showing a reference manner between predicted frames and a key frame in a picture group. For each predicted frame in the picture group, the key frame in the picture group is uniquely referred to so as to perform encoding to obtain the encoded file.

In the implementation, the spatial picture sequence is encoded in a reference manner in which the predicted frames in the picture group uniquely refer to the key frame in the picture group, which reduces the complexity of the relationship between the predicted frame and the key frame in the encoded file and facilitates the increase of the data determination speed and the decoding efficiency in the decoding process.

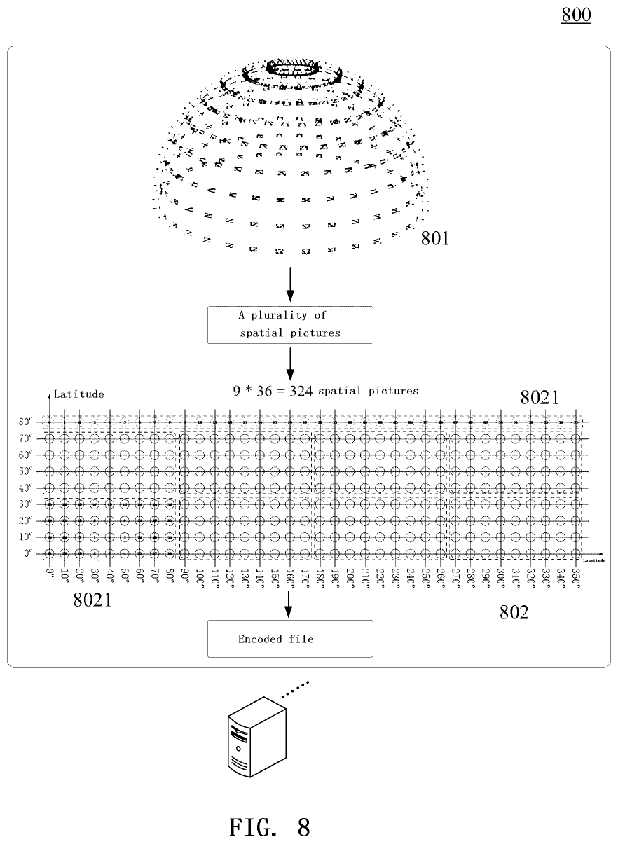

Reference is continued to be made to FIG. 8, which is a schematic diagram 800 of an application scenario of the encoding method suitable for a spatial image according to the embodiment. In the application scenario of FIG. 8, first, an image acquisition device is used to obtain a plurality of spatial pictures of the target object by performing sampling from the plurality of sampling points at different spatial angles. The spatial layout of the plurality of sampling points is as shown in 801. For the upper hemisphere of the target object, sampling is performed at intervals of 10°, so there are 36 sampling points in the longitude direction and 9 sampling points in the latitude direction, and there are 324 (36×9) sampling points in the upper hemisphere of the target object. Then, the target sizes of the sub-matrices corresponding to the different regions in the spatial picture matrix are determined in accordance with the degree of change between the adjacent spatial pictures in the spatial picture matrix; then, the spatial picture matrix 802 is divided with the sub-matrices 8021 corresponding to the different regions in the spatial picture matrix, and a plurality of picture groups are obtained; finally, the spatial pictures in the spatial picture matrix are encoded in accordance with respective key frames and predicted frames included in the plurality of picture groups, and an encoded file is generated.

The method provided by the aforesaid embodiments of the disclosure generates, in accordance with longitudes and latitudes corresponding to a plurality of sampling points at different spatial angles, a spatial picture matrix including a plurality of spatial pictures acquired by the plurality of sampling points; determines, in accordance with a degree of change between the adjacent spatial pictures in the spatial picture matrix, target sizes of sub-matrices corresponding to different regions in the spatial picture matrix; divides the spatial picture matrix with the sub-matrices corresponding to the different regions in the spatial picture matrix, and obtains a plurality of picture groups; and encodes, in accordance with respective key frames and predicted frames included in the plurality of picture groups, the spatial pictures in the spatial picture matrix, and generates an encoded file to thereby provide an encoding method suitable for a spatial picture. In the encoding process, the spatial pictures are reorganized to obtain the spatial picture matrix, and the picture groups in the spatial picture matrix are specified so as to manage the spatial pictures in the picture groups to achieve temporal decoupling of the spatial pictures; and the picture group encoding structure is determined by utilizing the spatial distribution characteristics of the spatial pictures, which increases the compression efficiency of the encoding process, facilitates the increase of the decoding efficiency, and reduces the memory usage of the decoding process.

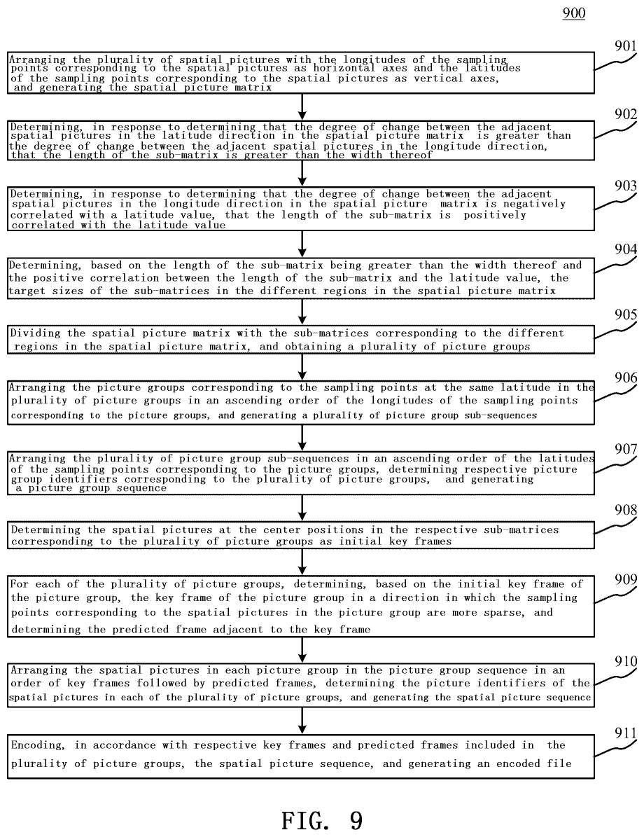

Reference is continued to be made to FIG. 9, which shows a schematic flow 900 of a further embodiment of the encoding method suitable for a spatial image according to the disclosure, comprising the following steps:

Step 901: arranging the plurality of spatial pictures with the longitudes of the sampling points corresponding to the spatial pictures as horizontal axes and the latitudes of the sampling points corresponding to the spatial pictures as vertical axes, and generating the spatial picture matrix.

Step 902: determining, in response to determining that the degree of change between the adjacent spatial pictures in the latitude direction in the spatial picture matrix is greater than the degree of change between the adjacent spatial pictures in the longitude direction, that the length of the sub-matrix is greater than the width thereof.

The length direction of the sub-matrix corresponds to the longitude direction of the sampling point, and the width direction of the sub-matrix corresponds to the latitude direction of the sampling point.

Step 903: determining, in response to determining that the degree of change between the adjacent spatial pictures in the longitude direction in the spatial picture matrix is negatively correlated with a latitude value, that the length of the sub-matrix is positively correlated with the latitude value.

Step 904: determining, based on the length of the sub-matrix being greater than the width thereof and the positive correlation between the length of the sub-matrix and the latitude value, the target sizes of the sub-matrices in the different regions in the spatial picture matrix.

Step 905: dividing the spatial picture matrix with the sub-matrices corresponding to the different regions in the spatial picture matrix, and obtaining a plurality of picture groups.

Step 906: arranging the picture groups corresponding to the sampling points at the same latitude in the plurality of picture groups in an ascending order of the longitudes of the sampling points corresponding to the picture groups, and generating a plurality of picture group sub-sequences.

Step 907: arranging the plurality of picture group sub-sequences in an ascending order of the latitudes of the sampling points corresponding to the picture groups, determining respective picture group identifiers corresponding to the plurality of picture groups, and generating a picture group sequence.

Step 908: determining the spatial pictures at the center positions in the respective sub-matrices corresponding to the plurality of picture groups as initial key frames.

Step 909: for each of the plurality of picture groups, determining, based on the initial key frame of the picture group, the key frame of the picture group in a direction in which the sampling points corresponding to the spatial pictures in the picture group are more sparse, and determining the predicted frame adjacent to the key frame.

Step 910: arranging the spatial pictures in each picture group in the picture group sequence in an order of key frames followed by predicted frames, determining the picture identifiers of the spatial pictures in each of the plurality of picture groups, and generating the spatial picture sequence.

Step 911: encoding, in accordance with respective key frames and predicted frames included in the plurality of picture groups, the spatial picture sequence, and generating an encoded file.

It may be seen from the embodiment that as compared with the embodiment corresponding to FIG. 2, the flow 900 of the encoding method suitable for a spatial image in the embodiment specifically illustrates the generation process of the spatial picture matrix, the determination process of the target sizes of the sub-matrices, the determination process of the spatial picture sequence, and the determination process of the key frame in the picture group, which sufficiently utilizes the spatial distribution characteristics of the spatial pictures, determines the encoding structure of the picture group, further increases the compression efficiency of the encoding process, facilitates the increase of the decoding efficiency, and reduces the memory usage of the decoding process.

For the encoded files obtained in the flows 200 and 900 in the aforesaid embodiments, a schematic flow of an embodiment of a decoding method suitable for a spatial picture is provided, the method comprising the following steps:

The first step: determining the target longitude and latitude corresponding to the target spatial picture desired by the user in accordance with the acquired operation information.

In the embodiment, the execution subject of the decoding method suitable for a spatial picture (e.g., the terminal device or the server in FIG. 1) may determine the target longitude and latitude corresponding to the target spatial picture desired by the user in accordance with the acquired operation information.

The operation information may be an action instruction corresponding to the sliding operation of the user or a voice instruction corresponding to the voice information. Reference is continued to be made to FIG. 10, which shows an operation track of the user in the spatial picture matrix. Along with the operation track, the aforesaid execution subject aims to decode the spatial picture data of the corresponding position, and obtain and display the target spatial picture desired by the user.

As an example, the aforesaid execution subject may pre-establish a correspondence between the operation position of the user on the screen and the target longitude and latitude corresponding to the target spatial picture desired by the user, so as to determine the target longitude and latitude corresponding to the target spatial picture desired by the user in real time during the execution of the operation action by the user. The target longitude and latitude corresponding to the target spatial picture are just the longitude and latitude corresponding to the sampling point corresponding to the target spatial picture.

The second step: determining the position information of the target spatial picture and the key frame in the target picture group to which the target spatial picture belongs in the encoded file in accordance with the target longitude and latitude.

In the embodiment, the aforesaid execution subject may determine the position information of the target spatial picture and the key frame in the target picture group to which the target spatial picture belongs in the encoded file in accordance with the target longitude and latitude.

The position information includes the position information of the target spatial picture in the encoded file and the position information of the key frame in the target picture group to which the target spatial picture belongs in the encoded file.

As an example, the aforesaid execution subject may pre-establish a correspondence between the longitude and latitude corresponding to each spatial picture involved in the encoded file and the position information of the spatial picture in the encoded file. Thus, the position information of the target spatial picture in the encoded file is determined in accordance with the target longitude and latitude; the key frame longitude and latitude of the key frame in the target picture group to which the target spatial picture belongs is determined in accordance with the target longitude and latitude, and then the position information of the key frame in the encoded file is determined.

In some optional implementations of the embodiment, the aforesaid execution subject may perform the aforesaid second step in the following manner:

First, the target picture group identifier of the target picture group to which the target spatial picture belongs and the target picture identifier of the target spatial picture are determined in accordance with the target longitude and latitude and the key frame longitudes and latitudes of the key frames in the respective picture groups in the encoded file.

As an example, the aforesaid execution subject may determine the key frame longitudes and latitudes of the key frames in the respective picture groups in the encoded file, and generate a set of key frame longitudes and latitudes; then, the target longitude and latitude are compared with the key frame longitudes and latitudes in the set of key frame longitudes and longitudes, and the target picture group to which the target spatial picture belongs is determined in accordance with the comparison result between the target longitude and latitude and the respective key frame longitudes and latitudes in the set of key frame longitudes and longitudes; then, the target picture group identifier of the target picture group and the target picture identifier of the target spatial picture are determined.

Reference is continued to be made to FIG. 5, where the corresponding set of key frame longitudes and latitudes is as follows:

$$GOPs = \{ \begin{matrix}( 40 , 10 ) , ( 130 , 10 ) , ( 220 , 10 ) , ( 310 , 10 ) , \\ ( 40 , 50 ) , ( 130 , 50 ) , ( 220 , 50 ) , ( 310 , 50 ) , \\ ( 0 , 80 ) ,\end{matrix} \}$$

Then, the position information is determined in accordance with the target picture group identifier and the target picture identifier.

In the process of performing encoding to obtain the encoded file, the spatial picture identifier of the spatial picture and the picture group identifier of the picture group to which the spatial picture belongs will be generally encoded. After determining the target picture group identifier and the target picture identifier, the position information of the target spatial picture in the encoded file and the position information of the key frame in the target picture group to which the target spatial picture belongs in the encoded file can be determined in the encoded file.

In the implementation, a specific implementation manner for determining the position information of the target spatial picture in the encoded file and the position information of the key frame in the target picture group to which the target spatial picture belongs in the encoded file is provided, which increases the determination efficiency and accuracy of the position information determination process.

In some optional implementations of the embodiment, the aforesaid execution subject may determine the target picture group identifier and the target picture identifier in the following manner: first, the picture group to which the key frame corresponding to the key frame longitude and latitude closest to the target longitude and latitude in the key frame longitudes and latitudes of the key frames in the respective picture groups in the encoded file belongs is used as the target picture group, and the target picture group identifier is determined; then, the target picture identifier is determined in accordance with an offset between the target longitude and latitude and the key frame longitude and latitude corresponding to the key frame in the target picture group.

As an example, the target longitude and latitude are (60, 20), which are closest to the key frame longitude and latitude (40, 10) in the set of key frame longitudes and latitudes, so the picture group GOP1 to which the key frame corresponding to the key frame longitude and longitude (40, 10) belongs is used as the target picture group, and the target picture group identifier is determined to be 1.

Then, the offset between the target longitude and latitude and the key frame longitude and latitude corresponding to the key frame in the target picture group is determined to be (20, 10), and the target picture identifier is determined to be 13.

The sub-matrices shown in FIG. 5 are continued to be used as an example, where the offsets between the longitudes and latitudes corresponding to the spatial pictures and the key frame longitudes and latitudes corresponding to the key frames in the picture groups GOP1-GOP8 are as follows:

$$OFFSETs\_ 1 \_ 8 = \{ \begin{matrix}( - 40 , 20 ) , ( - 30 , 20 ) , ( - 20 , 20 ) , ( - 10 , 20 ) , ( 0 , 20 ) , \\ ( 10 , 20 ) , ( 20 , 20 ) , ( 30 , 20 ) , ( 40 , 20 ) , \\ ( - 40 , 10 ) , ( - 30 , 10 ) , ( - 20 , 10 ) , ( - 10 , 10 ) , ( 0 , 10 ) , \\ ( 10 , 10 ) , ( 20 , 10 ) , ( 30 , 10 ) , ( 40 , 10 ) , \\ ( - 40 , 0 ) , ( - 30 , 0 ) , ( - 20 , 0 ) , ( - 10 , 0 ) , ( 0 , 0 ) , \\ ( 10 , 0 ) , ( 20 , 0 ) , ( 30 , 0 ) , ( 40 , 0 ) , \\ ( - 40 , - 10 ) , ( - 30 , - 10 ) , ( - 20 , - 10 ) , ( - 10 , - 10 ) , ( 0 , - 10 ) , \\ ( 10 , - 10 ) , ( 20 , - 10 ) , ( 30 , - 10 ) , ( 40 , - 10 ) ,\end{matrix} \}$$

The offsets between the longitudes and latitudes corresponding to the spatial pictures and the key frame longitude and latitude corresponding to the key frame in the picture group GOP9 are as follows:

$$OFFSETs\_ 9 = \{ \begin{matrix}( 0 , 0 ) , ( 10 , 0 ) , ( 20 , 0 ) , ( 30 , 0 ) , ( 40 , 0 ) , \\ ( 50 , 0 ) , ( 60 , 0 ) , ( 70 , 0 ) , ( 80 , 0 ) , \\ ( 90 , 0 ) , ( 100 , 0 ) , ( 110 , 0 ) , ( 120 , 0 ) , ( 130 , 0 ) , \\ ( 140 , 0 ) , ( 150 , 0 ) , ( 160 , 0 ) , ( 170 , 0 ) , \\ ( 180 , 0 ) , ( 190 , 0 ) , ( 200 , 0 ) , ( 210 , 0 ) , ( 220 , 0 ) , \\ ( 230 , 0 ) , ( 240 , 0 ) , ( 250 , 0 ) , ( 260 , 0 ) , \\ ( 270 , 0 ) , ( 280 , 0 ) , ( 290 , 0 ) , ( 300 , 0 ) , ( 310 , 0 ) , \\ ( 320 , 0 ) , ( 330 , 0 ) , ( 340 , 0 ) , ( 350 , 0 ) ,\end{matrix} \}$$

The aforesaid offset sets are re-sorted in accordance with the arrangement orders of the spatial pictures in the picture sequences corresponding to the picture groups in the encoding process, and sorted offset sequences are obtained; the target picture identifier corresponding to the target spatial picture may be determined in accordance with the sorted offset sequence and the obtained offset.

In the implementation, the target picture group identifier of the target picture group is determined in accordance with the comparison result between the key frame longitudes and latitudes of the respective key frames involved in the encoded file and the target longitude and latitude of the target spatial picture desired by the user, and then the target picture identifier is determined, which increases the versatility and accuracy of the identifier information determination process.

The third step: decoding the data at the position represented by the position information in the encoded file, and obtaining the target spatial picture.

In the example, the aforesaid execution subject may decode the data at the position represented by the position information in the encoded file, and obtain the target spatial picture.

After determining the position information of the target data to be decoded, the encoded data at the corresponding position in the encoded file may be decoded, and the target spatial picture may be decoded and displayed.

In some optional implementations of the embodiment, the aforesaid execution subject may perform the third step in the following manner:

First, it is determined, in accordance with the target picture identifier, whether the target spatial picture is a key frame in the target picture group or a predicted frame in the target picture group.

As an example, when it is determined that the target picture identifier is the same as the key frame identifier of the key frame in the target picture group, it is determined that the target spatial picture is the key frame in the target picture group; when it is determined that the target picture identifier is the same as the predicted frame identifier of the predicted frame in the target picture group, it is determined that the target spatial picture is the predicted frame in the target picture group.

Then, in response to determining that the target spatial picture is a predicted frame in the target picture group, the key frame in the target picture group at the position represented by the position information and the predicted frame corresponding to the target picture identifier are decoded, and the target spatial picture is obtained.

When the target spatial picture is a predicted frame in the target picture group, since the predicted frame refers to the key frame in the picture group, it is required to simultaneously decode the key frame in the target picture group at the position represented by the position information and the predicted frame corresponding to the target picture identifier so as to obtain the target spatial picture.

In some optional implementations of the embodiment, the aforesaid execution subject may also perform the aforesaid third step in the following manner: decoding, in response to determining that the target spatial picture is the key frame in the target picture group, the key frame in the target picture group at the position represented by the position information, and obtaining the target spatial picture.

When the target spatial picture is the key frame in the target picture group, the key frame in the target picture group at the position represented by the position information may be directly decoded, and the target spatial picture may be obtained without referring to other spatial pictures.

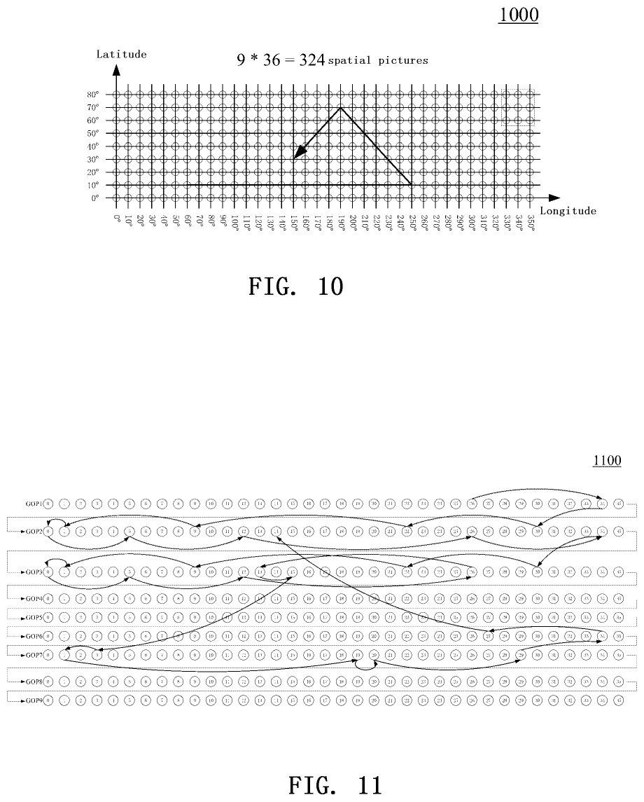

Reference is continued to be made to FIG. 11, which is a schematic diagram 1100 showing a decoding track corresponding to the operation track in FIG. 10. In the embodiment, the target longitude and latitude corresponding to the target spatial picture desired by the user is determined in accordance with the obtained operation information; the position information of the target spatial picture in the encoded file and the position information of the key frame in the target picture group to which the target spatial picture belongs in the encoded file are determined in accordance with the target longitude and latitude; the data at the position represented by the position information in the encoded file is decoded, and the target spatial picture is obtained to thereby provide a decoding method suitable for a spatial picture. Since the spatial pictures in the encoded file are temporally decoupled, the target longitude and latitude are mapped to the position of the corresponding data in the encoded file to thereby achieve decoding at any position and increase the flexibility of decoding.

For the encoded files obtained in the flows 200 and 900 in the aforesaid embodiments, a schematic flow of another embodiment of the decoding method suitable for a spatial picture is provided, the method comprising the following steps:

The first step: determining, in accordance with the obtained operation information, the target longitude and latitude corresponding to the target spatial picture desired by the user.

The second step: using the picture group to which the key frame corresponding to the key frame longitude and latitude closest to the target longitude and latitude in the key frame longitudes and latitudes of the key frames in the respective picture groups in the encoded file belongs as the target picture group, and determining the target picture group identifier.

The third step: determining the target picture identifier in accordance with the offset between the target longitude and latitude and the key frame longitude and latitude corresponding to the key frame in the target picture group.

The fourth step: determining, in accordance with the target picture group identifier and the target picture identifier, the position information of the target spatial picture in the encoded file and the position information of the key frame in the target picture group to which the target spatial picture belongs in the encoded file.

The fifth step: determining, in accordance with the target picture identifier, whether the target spatial picture is a key frame in the target picture group or a predicted frame in the target picture group.

The sixth step: decoding, in response to determining that the target spatial picture is a predicted frame in the target picture group, the key frame in the target picture group at the position represented by the position information and the predicted frame corresponding to the target picture identifier, and obtaining the target spatial picture.

The seventh step: decoding, in response to determining that the target spatial picture is a key frame in the target picture group, the key frame in the target picture group at the position represented by the position information, and obtaining the target spatial picture.

It may be seen from the embodiment that as compared with the aforesaid embodiment of the decoding method, the flow of the decoding method suitable for a spatial picture in the embodiment specifically illustrates the determination process of the position information and the decoding process of the target spatial picture, which further increases the efficiency and flexibility of the decoding process of the spatial picture.

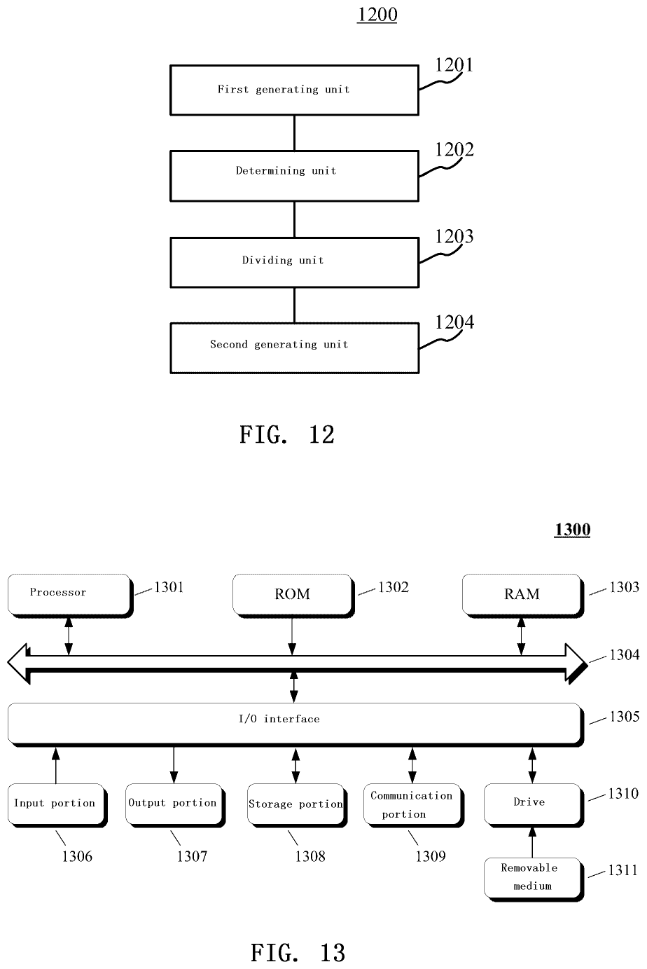

Reference is continued to be made to FIG. 12, where as an implementation of the methods shown in the aforesaid respective figures, the disclosure provides an embodiment of an encoding apparatus suitable for a spatial image. The apparatus embodiment corresponds to the method embodiment shown in FIG. 2, and the apparatus may be specifically applied to various electronic devices.

As shown in FIG. 12, the encoding apparatus suitable for a spatial image comprises: a first generating unit 1201 configured to generate, in accordance with longitudes and latitudes corresponding to a plurality of sampling points at different spatial angles, a spatial picture matrix including a plurality of spatial pictures acquired by the plurality of sampling points; a determining unit 1202 configured to determine, in accordance with a degree of change between the adjacent spatial pictures in the spatial picture matrix, target sizes of sub-matrices corresponding to different regions in the spatial picture matrix; a dividing unit 1203 configured to divide the spatial picture matrix with the sub-matrices corresponding to the different regions in the spatial picture matrix, and obtain a plurality of picture groups; and a second generating unit 1204 configured to encode, in accordance with respective key frames and predicted frames included in the plurality of picture groups, the spatial pictures in the spatial picture matrix, and generate an encoded file.

In some optional implementations of the embodiment, the aforesaid determining unit 1202 is further configured to: determine, based on a negative correlation between the degree of change between the adjacent spatial pictures in the spatial picture matrix and the target sizes of the sub-matrices, the target sizes of the sub-matrices corresponding to the different regions in the spatial picture matrix.

In some optional implementations of the embodiment, the aforesaid adjacent sampling points among the plurality of sampling points are arranged at intervals of a preset degree in a longitude direction and a latitude direction, and the aforesaid determining unit 1202 is further configured to: determine, in response to determining that the degree of change between the adjacent spatial pictures in the latitude direction in the spatial picture matrix is greater than the degree of change between the adjacent spatial pictures in the longitude direction, that the length of the sub-matrix is greater than the width thereof, wherein the length direction of the sub-matrix corresponds to the longitude direction of the sampling point, and the width direction of the sub-matrix corresponds to the latitude direction of the sampling point; determine, in response to determining that the degree of change between the adjacent spatial pictures in the longitude direction in the spatial picture matrix is negatively correlated with a latitude value, that the length of the sub-matrix is positively correlated with the latitude value; and determine, based on the length of the sub-matrix being greater than the width thereof and the positive correlation between the length of the sub-matrix and the latitude value, the target sizes of the sub-matrices in the different regions in the spatial picture matrix.

In some optional implementations of the embodiment, the aforesaid first generating unit is further configured to: arrange the plurality of spatial pictures with the longitudes of the sampling points corresponding to the spatial pictures as horizontal axes and the latitudes of the sampling points corresponding to the spatial pictures as vertical axes, and generate the spatial picture matrix.

In some optional implementations of the embodiment, the aforesaid second generating unit 1201 is further configured to: arrange the picture groups corresponding to the sampling points at the same latitude in the plurality of picture groups in an ascending order of the longitudes of the sampling points corresponding to the picture groups, and generate a plurality of picture group sub-sequences; arrange the plurality of picture group sub-sequences in an ascending order of the latitudes of the sampling points corresponding to the picture groups, determine respective picture group identifiers corresponding to the plurality of picture groups, and generate a picture group sequence; arrange the spatial pictures in each picture group in the picture group sequence in an order of key frames followed by predicted frames, determine a picture identifier of the spatial picture in each of the plurality of picture groups, and generate a spatial picture sequence; and encode, in accordance with the respective key frames and predicted frames included in the plurality of picture groups, the spatial picture sequence, and generate the encoded file.

In some optional implementations of the embodiment, the aforesaid second generating unit 1204 is further configured to: determine the spatial pictures at the center positions in the respective sub-matrices corresponding to the plurality of picture groups as initial key frames; for each of the plurality of picture groups, determine, based on the initial key frame of the picture group, the key frame of the picture group in a direction in which the sampling points corresponding to the spatial pictures in the picture group are more sparse, and determine the predicted frame adjacent to the key frame; and arrange the spatial pictures in each picture group in the picture group sequence in an order of key frames followed by predicted frames, determine the picture identifiers of the spatial pictures in each of the plurality of picture groups, and generate the spatial picture sequence.

In some optional implementations of the embodiment, the aforesaid second generating unit 1204 is further configured to: for each of the plurality of picture groups, encode the spatial picture sequence in a reference manner in which the predicted frames in the picture group uniquely refer to the key frame in the picture group, and generate the encoded file.

In the embodiment, in the encoding apparatus suitable for a spatial image, the first generating unit generates, in accordance with longitudes and latitudes corresponding to a plurality of sampling points at different spatial angles, a spatial picture matrix including a plurality of spatial pictures acquired by the plurality of sampling points; the determining unit determines, in accordance with a degree of change between the adjacent spatial pictures in the spatial picture matrix, target sizes of sub-matrices corresponding to different regions in the spatial picture matrix; the dividing unit divides the spatial picture matrix with the sub-matrices corresponding to the different regions in the spatial picture matrix, and obtains a plurality of picture groups; and the second generating unit encodes, in accordance with respective key frames and predicted frames included in the plurality of picture groups, the spatial pictures in the spatial picture matrix, and generates an encoded file to thereby provide an encoding method suitable for a spatial picture. In the encoding process, the spatial pictures are reorganized to obtain the spatial picture matrix, and the picture groups in the spatial picture matrix are specified so as to manage the spatial pictures in the picture groups to achieve temporal decoupling of the spatial pictures; and the picture group encoding structure is determined by utilizing the spatial distribution characteristics of the spatial pictures, which increases the compression efficiency of the encoding process, facilitates the increase of the decoding efficiency, and reduces the memory usage of the decoding process.

Reference is now made to FIG. 13, which shows a schematic diagram of a structure of a computer system 1300 suitable for implementing a device (e.g., the devices 101, 102, 103 and 105 as shown in FIG. 1) according to an embodiment of the disclosure. The device shown in FIG. 13 is only an example, and shall not impose any limitation on the functions and the scope of use of the embodiment of the disclosure.

As shown in FIG. 13, the computer system 1300 includes a processor (e.g., CPU, a central processing unit) 1301, which may perform various appropriate actions and processes according to a program stored in a read-only memory (ROM) 1302 or a program loaded from a storage portion 1308 into a random access memory (RAM) 1303. Various programs and data required for the operation of the system 1300 are also stored in the RAM 1303. The processor 1301, the ROM 1302 and the RAM 1303 are connected to each other through a bus 1304. An input/output (I/O) interface 1305 is also connected to the bus 1304.

The following components are connected to the I/O interface 1305: an input portion 1306 including a keyboard, a mouse, and so on; an output portion 1307 including a cathode ray tube (CRT), a liquid crystal display (LCD) and so on, and a speaker and so on; a storage portion 1308 including a hard disk and so on; and a communication portion 1309 including a network interface card such as a LAN card, a modem, and so on. The communication portion 1309 performs communication processing via a network such as the Internet. A drive 1310 is also connected to the I/O interface 1305 according to requirements. A removable medium 1311, such as a magnetic disk, an optical disk, a magneto-optical disk, a semiconductor memory, and so on, is installed on the drive 1310 according to requirements so that a computer program read therefrom is installed in the storage portion 1308 according to requirements.

In particular, according to the embodiment of the disclosure, the process described above with reference to the flowchart may be implemented as a computer software program. For example, the embodiment of the disclosure includes a computer program product, which includes a computer program carried on a computer-readable medium, the computer program containing a program code for performing the method shown in the flowchart. In such embodiment, the computer program may be downloaded and installed from the network through the communication portion 1309, and/or installed from the removable medium 1311. When the computer program is executed by the processor 1301, the aforesaid functions defined in the method according to the disclosure are executed.

It shall be noted that the computer-readable medium shown in the disclosure may be a computer-readable signal medium or a computer-readable storage medium or any combination of the aforesaid two media. The computer-readable storage medium may be, for example, but not limited to, an electronic, magnetic, optical, electromagnetic, infrared, or semiconductor system, apparatus or device, or any combination thereof. More specific examples of the computer-readable storage medium may include, but are not limited to, an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the disclosure, the computer-readable storage medium may be any tangible medium containing or storing a program, and the program may be used by or in combination with an instruction execution system, apparatus or device. In the disclosure, the computer-readable signal medium may include a data signal propagated in a baseband or propagated as a part of a carrier wave, in which a computer-readable program code is carried. Such propagated data signal may adopt multiple forms, including but not limited to electromagnetic signals, optical signals, or any suitable combination thereof. The computer-readable signal medium may also be any computer-readable medium other than the computer-readable storage medium, and the computer-readable medium may send, propagate, or transmit a program used by or in combination with the instruction execution system, apparatus or device. The program code contained on the computer-readable medium may be transmitted using any appropriate medium, including but not limited to wireless, wire, optical cable, RF, and so on, or any suitable combination thereof.

Computer program codes for performing operations of the disclosure may be written in one or more programming languages, including object-oriented programming languages such as Java, Smalltalk, and C++, and further including conventional procedural programming languages such as the “C” programming language or similar programming languages, or a combination thereof. The program codes may be executed entirely on a client computer, partly on the client computer, as an independent software package, partly on the client computer and partly on a remote computer, or entirely on the remote computer or a server. In a case involving a remote computer, the remote computer may be connected to the client computer by means of any type of network, including a local area network (LAN) or a wide area network (WAN), or may be connected to an external computer (e.g., by means of the Internet using an Internet service provider).

The flowcharts and block diagrams in the figures illustrate architectures, functions and operations that may be implemented by apparatuses, methods and computer program products according to various embodiments of the disclosure. In this regard, each block in the flowcharts or block diagrams may represent a module, a program segment, or a part of a code, which contains one or more executable instructions for implementing specified logic functions. It shall also be noted that in some alternative implementations, the functions labeled in the blocks may also occur in an order different from that labeled in the figures. For example, two successively represented blocks may actually be executed substantially in parallel, and they may sometimes be executed in a reverse order, which depends on the functions involved. It shall also be noted that each block in the block diagrams and/or flowcharts, and combinations of the blocks in the block diagrams and/or flowcharts may be implemented with a dedicated hardware-based system that performs specified functions or operations, or may be implemented with a combination of dedicated hardware and computer instructions.

The involved units described in the embodiment of the disclosure may be implemented by software or hardware. The described units may also be provided in a processor. For example, descriptions may be made as follows: a processor comprising a first generating unit, a determining unit, a dividing unit and a second generating unit. The names of these units do not form limitations of the units themselves in some cases. For example, the determining unit may also be described as follows: “a unit that determines, in accordance with a degree of change between the adjacent spatial pictures in the spatial picture matrix, target sizes of sub-matrices corresponding to different regions in the spatial picture matrix”.

As another aspect, the disclosure also provides a computer-readable medium, which may be included in the devices described in the aforesaid embodiment, or may exist independently without being assembled into the devices. The aforesaid computer-readable medium carries one or more programs, and the one or more programs, when executed by one of the devices, cause the device to: generate, in accordance with longitudes and latitudes corresponding to a plurality of sampling points at different spatial angles, a spatial picture matrix including a plurality of spatial pictures acquired by the plurality of sampling points; determine, in accordance with a degree of change between the adjacent spatial pictures in the spatial picture matrix, target sizes of sub-matrices corresponding to different regions in the spatial picture matrix; divide the spatial picture matrix with the sub-matrices corresponding to the different regions in the spatial picture matrix, and obtain a plurality of picture groups; and encode, in accordance with respective key frames and predicted frames included in the plurality of picture groups, the spatial pictures in the spatial picture matrix, and generate an encoded file.

The descriptions above are only preferred embodiments of the disclosure and explanations of the technical principles used. Those skilled in the art should understand that the scope of the invention involved in the disclosure is not limited to the technical solutions formed by the specific combinations of the aforesaid technical features, but shall also cover other technical solutions formed by any combination of the aforesaid technical features or their equivalent features without departing from the aforesaid inventive concept, such as the technical solutions formed by replacing the aforesaid features with the technical features having similar functions disclosed in the disclosure (but not limited thereto).

1. An encoding method suitable for a spatial image, comprising:
generating, in accordance with longitudes and latitudes corresponding to a plurality of sampling points at different spatial angles, a spatial picture matrix including a plurality of spatial pictures acquired by the plurality of sampling points;
determining, in accordance with a degree of change between the adjacent spatial pictures in the spatial picture matrix, target sizes of sub-matrices corresponding to different regions in the spatial picture matrix;
dividing the spatial picture matrix with the sub-matrices corresponding to the different regions in the spatial picture matrix, and obtaining a plurality of picture groups; and
encoding, in accordance with respective key frames and predicted frames included in the plurality of picture groups, the spatial pictures in the spatial picture matrix, and generating an encoded file.

2. The method according to claim 1, wherein determining, in accordance with a degree of change between the adjacent spatial pictures in the spatial picture matrix, target sizes of sub-matrices corresponding to different regions in the spatial picture matrix comprises:
determining, based on a negative correlation between the degree of change between the adjacent spatial pictures in the spatial picture matrix and the target sizes of the sub-matrices, the target sizes of the sub-matrices corresponding to the different regions in the spatial picture matrix.

3. The method according to claim 2, wherein the adjacent sampling points among the plurality of sampling points are arranged at intervals of a preset degree in a longitude direction and a latitude direction, and
determining, based on a negative correlation between the degree of change between the adjacent spatial pictures in the spatial picture matrix and the target sizes of the sub-matrices, the target sizes of the sub-matrices corresponding to the different regions in the spatial picture matrix comprises:
determining, in response to determining that the degree of change between the adjacent spatial pictures in the latitude direction in the spatial picture matrix is greater than the degree of change between the adjacent spatial pictures in the longitude direction, that the length of the sub-matrix is greater than the width thereof, wherein the length direction of the sub-matrix corresponds to the longitude direction of the sampling point, and the width direction of the sub-matrix corresponds to the latitude direction of the sampling point;
determining, in response to determining that the degree of change between the adjacent spatial pictures in the longitude direction in the spatial picture matrix is negatively correlated with a latitude value, that the length of the sub-matrix is positively correlated with the latitude value; and
determining, based on the length of the sub-matrix being greater than the width thereof and the positive correlation between the length of the sub-matrix and the latitude value, the target sizes of the sub-matrices in the different regions in the spatial picture matrix.

4. The method according to claim 1, wherein generating, in accordance with longitudes and latitudes corresponding to a plurality of sampling points at different spatial angles, a spatial picture matrix including a plurality of spatial pictures acquired by the plurality of sampling points comprises:
arranging the plurality of spatial pictures with the longitudes of the sampling points corresponding to the spatial pictures as horizontal axes and the latitudes of the sampling points corresponding to the spatial pictures as vertical axes, and generating the spatial picture matrix.

5. The method according to claim 1, wherein encoding, in accordance with respective key frames and predicted frames included in the plurality of picture groups, the spatial pictures in the spatial picture matrix, and generating an encoded file comprise:
arranging the picture groups corresponding to the sampling points at the same latitude in the plurality of picture groups in an ascending order of the longitudes of the sampling points corresponding to the picture groups, and generating a plurality of picture group sub-sequences;
arranging the plurality of picture group sub-sequences in an ascending order of the latitudes of the sampling points corresponding to the picture groups, determining respective picture group identifiers corresponding to the plurality of picture groups, and generating a picture group sequence;
arranging the spatial pictures in each picture group in the picture group sequence in an order of key frames followed by predicted frames, determining picture identifiers of the spatial pictures in each of the plurality of picture groups, and generating a spatial picture sequence; and
encoding, in accordance with the respective key frames and predicted frames included in the plurality of picture groups, the spatial picture sequence, and generating the encoded file.

6. The method according to claim 5, wherein arranging the spatial pictures in each picture group in the picture group sequence in an order of key frames followed by predicted frames, determining picture identifiers of the spatial pictures in each of the plurality of picture groups, and generating a spatial picture sequence comprise:
determining the spatial pictures at the center positions in the respective sub-matrices corresponding to the plurality of picture groups as initial key frames;
for each of the plurality of picture groups, determining, based on the initial key frame of the picture group, the key frame of the picture group in a direction in which the sampling points corresponding to the spatial pictures in the picture group are more sparse, and determining the predicted frame adjacent to the key frame; and
arranging the spatial pictures in each picture group in the picture group sequence in an order of key frames followed by predicted frames, determining the picture identifiers of the spatial pictures in each of the plurality of picture groups, and generating the spatial picture sequence.

7. The method according to claim 5, wherein encoding, in accordance with the respective key frames and predicted frames included in the plurality of picture groups, the spatial picture sequence, and generating the encoded file comprise:
for each of the plurality of picture groups, encoding the spatial picture sequence in a reference manner in which the predicted frames in the picture group uniquely refer to the key frame in the picture group, and generating the encoded file.

8. An encoding apparatus suitable for a spatial image, comprising:
a first generating unit configured to generate, in accordance with longitudes and latitudes corresponding to a plurality of sampling points at different spatial angles, a spatial picture matrix including a plurality of spatial pictures acquired by the plurality of sampling points;
a determining unit configured to determine, in accordance with a degree of change between the adjacent spatial pictures in the spatial picture matrix, target sizes of sub-matrices corresponding to different regions in the spatial picture matrix;
a dividing unit configured to divide the spatial picture matrix with the sub-matrices corresponding to the different regions in the spatial picture matrix, and obtain a plurality of picture groups; and
a second generating unit configured to encode, in accordance with respective key frames and predicted frames included in the plurality of picture groups, the spatial pictures in the spatial picture matrix, and generate an encoded file.

9. The encoding apparatus according to claim 8, wherein the determining unit is further configured to:
determine, based on a negative correlation between the degree of change between the adjacent spatial pictures in the spatial picture matrix and the target sizes of the sub-matrices, the target sizes of the sub-matrices corresponding to the different regions in the spatial picture matrix.

10. The encoding apparatus according to claim 8, wherein the adjacent sampling points among the plurality of sampling points are arranged at intervals of a preset degree in a longitude direction and a latitude direction, and
the determining unit is further configured to: determine, in response to determining that the degree of change between the adjacent spatial pictures in the latitude direction in the spatial picture matrix is greater than the degree of change between the adjacent spatial pictures in the longitude direction, that the length of the sub-matrix is greater than the width thereof, wherein the length direction of the sub-matrix corresponds to the longitude direction of the sampling point, and the width direction of the sub-matrix corresponds to the latitude direction of the sampling point;
determine, in response to determining that the degree of change between the adjacent spatial pictures in the longitude direction in the spatial picture matrix is negatively correlated with a latitude value, that the length of the sub-matrix is positively correlated with the latitude value; and
determine, based on the length of the sub-matrix being greater than the width thereof and the positive correlation between the length of the sub-matrix and the latitude value, the target sizes of the sub-matrices in the different regions in the spatial picture matrix.

11. The encoding apparatus according to claim 8, wherein the first generating unit is further configured to:
arrange the plurality of spatial pictures with the longitudes of the sampling points corresponding to the spatial pictures as horizontal axes and the latitudes of the sampling points corresponding to the spatial pictures as vertical axes, and generate the spatial picture matrix.

12. The encoding apparatus according to claim 8, wherein the second generating unit is further configured to:
arrange the picture groups corresponding to the sampling points at the same latitude in the plurality of picture groups in an ascending order of the longitudes of the sampling points corresponding to the picture groups, and generate a plurality of picture group sub-sequences;
arrange the plurality of picture group sub-sequences in an ascending order of the latitudes of the sampling points corresponding to the picture groups, determine respective picture group identifiers corresponding to the plurality of picture groups, and generate a picture group sequence;
arrange the spatial pictures in each picture group in the picture group sequence in an order of key frames followed by predicted frames, determine picture identifiers of the spatial pictures in each of the plurality of picture groups, and generate a spatial picture sequence; and
encode, in accordance with the respective key frames and predicted frames included in the plurality of picture groups, the spatial picture sequence, and generate the encoded file.

13. The encoding apparatus according to claim 12, wherein the second generating unit is further configured to:
determine the spatial pictures at the center positions in the respective sub-matrices corresponding to the plurality of picture groups as initial key frames;
for each of the plurality of picture groups, determine, based on the initial key frame of the picture group, the key frame of the picture group in a direction in which the sampling points corresponding to the spatial pictures in the picture group are more sparse, and determine the predicted frame adjacent to the key frame; and
arrange the spatial pictures in each picture group in the picture group sequence in an order of key frames followed by predicted frames, determine the picture identifiers of the spatial pictures in each of the plurality of picture groups, and generate the spatial picture sequence.

14. The encoding apparatus according to claim 12 or 13, wherein the second generating unit is further configured to:
for each of the plurality of picture groups, encode the spatial picture sequence in a reference manner in which the predicted frames in the picture group uniquely refer to the key frame in the picture group, and generate the encoded file.

15. A non-transitory computer-readable storage medium having a computer program stored thereon, which, when executed by a processor, implements the method according to claim 1.

16. An electronic device, comprising:
one or more processors; and
a storage means for storing one or more programs thereon, which, when executed by the one or more processors, cause the one or more processors to implement the method according to claim 1.

17. The method according to claim 6, wherein encoding, in accordance with the respective key frames and predicted frames included in the plurality of picture groups, the spatial picture sequence, and generating the encoded file comprise:
for each of the plurality of picture groups, encoding the spatial picture sequence in a reference manner in which the predicted frames in the picture group uniquely refer to the key frame in the picture group, and generating the encoded file.

18. The encoding apparatus according to claim 13, wherein the second generating unit is further configured to:
for each of the plurality of picture groups, encode the spatial picture sequence in a reference manner in which the predicted frames in the picture group uniquely refer to the key frame in the picture group, and generate the encoded file.
